(19) United States
(12) Patent Application Publication
(10) Pub. No.: US 2004/0172352 A1
(43) Pub. Date: Sep. 2, 2004

(54) Method and system for correlation risk hedging

(76) Inventor: Cyril Deretz, Paris (FR)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/772,103

(22) Filed: Feb. 4, 2004

Related U.S. Application Data
(60) Provisional application No. 60/444,647, filed on Feb. 4, 2003.

(51) Int. Cl. G06F 17/60

(52) U.S. Cl. 705/36

(57) ABSTRACT

Method and system for hedging the risk of correlation between a set of macro-economic variables, wherein at least one contract is built for a given duration and for at least two underlying variables selecting from said set, the payoff of the contract increasing with the correlation between the two variables and being lowly sensitive to the volatility level of the two variables.

### CROSS-REFERENCE TO RELATED APPLICATIONS

This application claims the benefit of the filing date of provisional application 60/444,647 filed Feb. 4, 2003, which is herein incorporated by reference.

### FIELD OF THE INVENTION

The present invention relates to a method and system that help financial market players to hedge themselves against the risk of correlation between major macro-economic factors.

### BACKGROUND OF THE INVENTION

Most innovations in financial markets have been made in the past by creating new risk hedging instruments. Risk hedging means immunizing against a specific risk, i.e. providing a protection against a very specific market factor.

The first hedging instruments were futures on commodities like gold, iron or oil on Chicago's CBOT. They provided traders with the ability to short sell and thereby hedge downside risk on the underlying prices.

Option contracts (calls and puts) are other risk hedging instruments. They give the right to the option buyer to buy or sell an underlying instrument (like a future, an equity share, a bond) at a predefined price on a predefined date. Options are like insurance contracts, the buyer pays a premium that protects his books against a potential downside or upside below or over a certain price. The premium of an option depends on the underlying asset's volatility which is a measurement of the amplitude and speed of its relative movements.

The globalization of the financial markets has demonstrated the effect of correlation between major macro-economic factors or between major markets and has increases the need of reducing this correlation risk.

Correlation is mathematically defined as a statistical measure that gives the strength of dependency of the relative movements between two variables. Many financial actors have a dependency on correlation, like insurances, mutual funds, hedge funds, banks, and so on. As a matter of fact, there is a very strong link between a correlation increase and short-term systemic (or global, or macro economic) risk, because when systemic risk increases, all assets have a tendency to become strongly correlated. In other words, correlation increases with systemic risk. Insurances and banks have a very strong interest to hedge their short-term systemic risk exposures.

There is an intuitive analogy to make between correlation and volatility. Currently, volatility is almost a commodity knowing that it is the options' main risk factor and that option “time value” is proportional to the implied volatility. The inversion of the Black-Scholes formula gives the level of the implied volatility for a given option price. But there is currently no liquid market that enables to trade correlation as one can do with volatility. It is therefore not yet possible to hedge correlation risk and there is no easy way to get implied correlation curves from the market.

Also, new products have been recently issued with a strong dependency on inter-equity correlation, those products cannot be used has a protection against correlation risk because they are over-the-counter (OTC) contracts and are not liquid enough, also because they cannot be short sold or because they have too many underlying products (they primarily depend on a basket of equities).

### SUMMARY OF THE INVENTION

It is an object of the present invention to propose a method and system to solve the abovementioned disadvantages and namely to propose a solution that enables correlation to be traded as a commodity on listed exchanges. It enables banks to do more accurate valuation and efficient risk-management on their complex positions. Some hedge funds may be interested in buying or selling correlation if they consider that the market doesn't price a realistic level (too cheap or too dear).

In accordance with the present invention, there is provided a method for correlation risk hedging comprising the steps of:

defining a plurality of underlying variables for which correlation risk is to be hedged,

for at least one group of at least two underlying variables from said plurality of underlying variables defining at least one contract for at least one product for a given duration,

defining a set of intermediate dates between initiation date of said at least one contract and expiry date of said at least one contract,

retrieving the intermediate performances of said at least two underlying variables, each intermediate performance being related to the time period between two successive intermediate dates,

calculating said final payoff from said intermediate performances, wherein said final payoff increases with the correlation of said at least two underlying variables and depends lowly on the volatility of said at least two underlying variables,

settlement of said at least one contract.

In accordance with a preferred embodiment of the present invention the method further includes the following features:

said underlying variables are macro-economic variables,

said at least one group of at least two underlying variables is restricted to a first underlying variable and a second underlying variable,

said final payoff at said expiry date is defined by the given formula:

$$p = 100 * [ 1 + \frac{{\sum }_{i = 1}^{n} {p}_{1} ( i ) {p}_{2} ( i )}{\sqrt{{\sum }_{i = 1}^{n} {[ {p}_{1} ( i ) ]}^{2}} \cdot \sqrt{{\sum }_{i = 1}^{n} {[ {p}_{2} ( i ) ]}^{2}}} ]$$

wherein n+1 is the number of said intermediate dates, the intermediate date 0 being said initiation date, p₁(i) is the performance between intermediate dates i-1 and i of said first underlying variable and p₂(i) is the performance between intermediate dates i-1 and i of said second underlying variable.

In accordance with the present invention, there is also provided a system for correlation risk hedging comprising:

means for defining a plurality of underlying variables for which correlation risk is to be hedged,

means for defining for at least one group of at least two underlying variables from said plurality of underlying variables at least one product associated to at least one contract of a given duration,

means for defining a set of intermediate dates between initiation date of said at least one contract and expiry date of said at least one contract,

means for retrieving the intermediate performances of said at least two underlying variables, each intermediate performance being related to the time period between two successive intermediate dates,

means for calculating said final payoff from said intermediate performances, wherein said final payoff increases with the correlation of said at least two underlying variables and depends lowly on the volatility of said at least two underlying variables.

In accordance with a preferred embodiment of the present invention the system further includes the following features:

said underlying variables are macro-economic variables,

said at least one group of at least two underlying variables is restricted to a first underlying variable and a second underlying variable.

said final payoff at said expiry date is defined by the given formula:

$$p = 100 * [ 1 + \frac{{\sum }_{i = 1}^{n} {p}_{1} ( i ) {p}_{2} ( i )}{\sqrt{{\sum }_{i = 1}^{n} {[ {p}_{1} ( i ) ]}^{2}} \cdot \sqrt{{\sum }_{i = 1}^{n} {[ {p}_{2} ( i ) ]}^{2}}} ]$$

wherein n+1 is the number of said intermediate dates, the intermediate date 0 being said initiation date, pᵢ(i) is the performance between intermediate dates i-1 and i of said first underlying variable and p₂(i) is the performance between intermediate dates i-1 and i of said second underlying variable.

### BRIEF DESCRIPTION OF THE DRAWINGS

Other features of the invention are further apparent from the following detailed description of presently preferred exemplary embodiments of the invention taken in conjunction with the accompanying drawings, of which:

FIG. 1 is a block diagram representing a computer system in which aspects of the present invention may be incorporated.

FIG. 2 is schematic diagram representing a computer network system wherein aspects of the invention may be incorporated.

FIG. 3 is an illustration of example market participants and exchange flows.

FIG. 4 is an illustration of the evolution of the correlation between two main indices.

FIG. 5 is an array illustrating how to define the product according to the invention.

FIG. 6 is a graph showing the price of a product defined according to the invention as a function of both underlying prices.

FIG. 7 illustrates the relationship between a high dependence on correlation and cross-gamma hedging and further illustrates that both functions have a hyperbolic paraboloid profile.

FIG. 8 is a graph showing the sensitivity of a product defined according to the invention to correlation level for different volatility levels.

FIG. 9 illustrates a model for determining the future price of an underlying asset by way of Monte Carlo simulation.

FIG. 10 provides a flow chart that illustrates the generation of the correlation derivative in accordance with an aspect of the invention.

### DETAILED DESCRIPTION OF ILLUSTRATIVE EMBODIMENTS

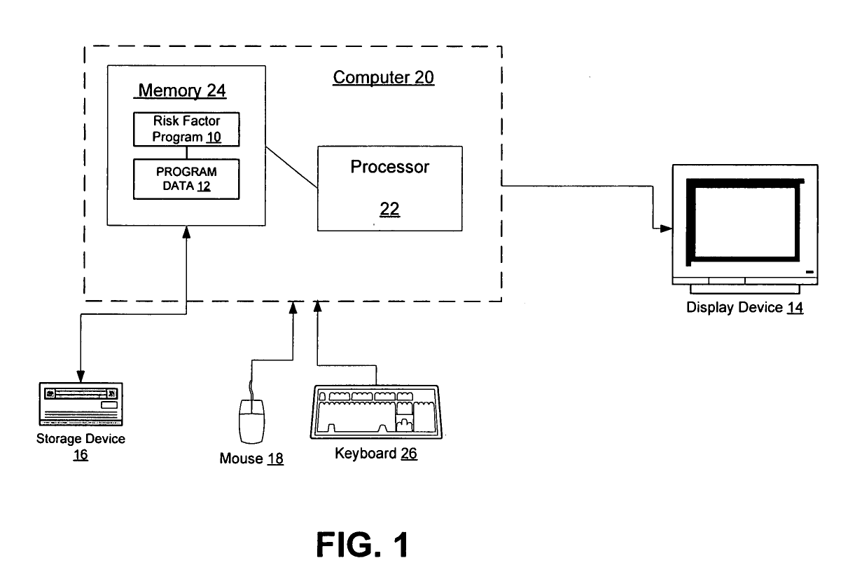

FIG. 1 provides a block diagram of an exemplary environment in which the invention may be implemented. Moreover, the invention is described herein in the context of flow charts and computer-executable instructions that operate on a computer system such as the system of FIG. 1. Generally, computer-executable instructions are contained in program modules such as programs, objects, data structures and the like that perform particular tasks. Those skilled in the art will appreciate that the invention may be practiced with other computer system configurations, including multi-processor systems, network PCs, minicomputers, mainframe computers and so on. The invention may also be practiced in distributed computing environments where tasks are performed by remote processing devices that are linked through a communications network.

FIG. 1 includes a general-purpose computing device in the form of a computer system 20, including a processing unit 22, and a system memory 24. The system memory could include read-only memory (ROM) and/or random access memory (RAM) and contains the program code 10 and data 12 for carrying out the present invention. The system further comprises a storage device 16, such as a magnetic disk drive, optical disk drive, or the like. The storage device 16 and its associated computer-readable media provides a non-volatile storage of computer readable instructions, data structures, program modules and other data for the computer system 20.

A user may enter commands and information into the computer system 20 by way of input devices such as a keyboard 26 and pointing device 18. A display device 14 such as a monitor is connected to the computer system 20 to provide visual indications for user input and output. In addition to the display device 14, computer system 20 may also include other peripheral output devices (not shown), such as a printer.

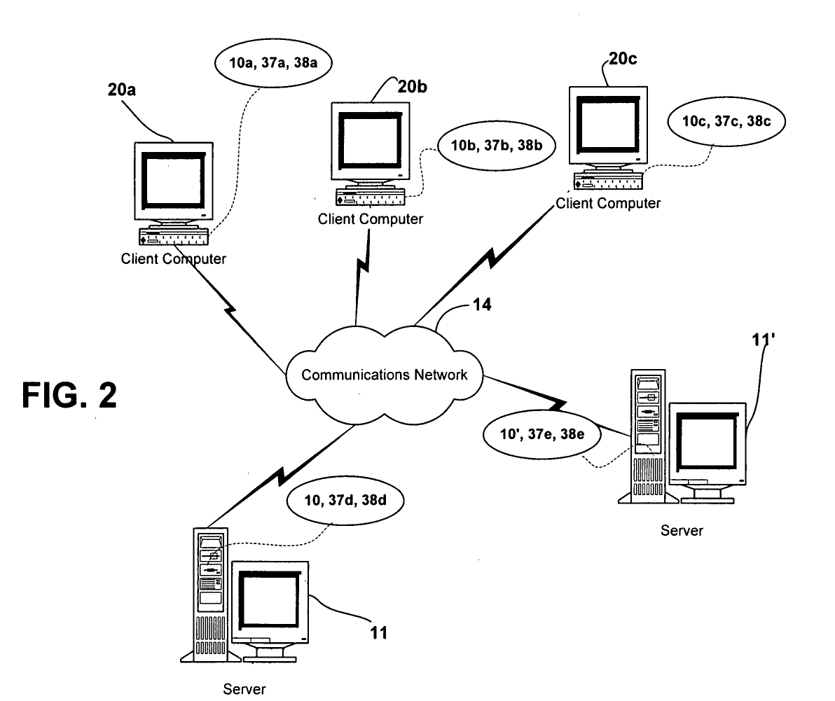

It should be noted that the computer described above can be deployed as part of a computer network, and that the present invention pertains to any computer system having any number of memory or storage units, and any number of applications and processes occurring across any number of volumes. Thus, the invention may apply to both server computers and client computers deployed in a network environment, having remote or local storage. FIG. 2 illustrates an exemplary network environment, with a server in communication with client computers via a network, in which the present invention may be employed. As shown, a number of servers 11, 11′, etc., are interconnected via a communications network 14 (which may be a LAN, WAN, intranet or the Internet) with a number of client computers 20a, 20b, 20c, etc. In a network environment in which the communications network 14 is the Internet, for example, the servers 11 can be Web servers with which the clients 20 communicate via any of a number of known protocols such as hypertext transfer protocol (HTTP).

Each client computer 20 and server computer 10 may be equipped with various application program modules 10, other program modules 37 and program data 38, and with connections or access to various types of storage elements or objects. Thus, each computer 10 or 20 may have financial information associated therewith, such as stock prices, interest rates, bond prices and so on. Each computer 20 may contain computer-executable instructions that model financial assets or risk associated with the assets. For example, one system may model financial derivatives based on a Black-Sholes model, whereas another may model interest rate derivatives based on a Heat-Jarrow-Morton model, and so on. These computers can then pass their respective data to the server computers 11 or other computers in the network.

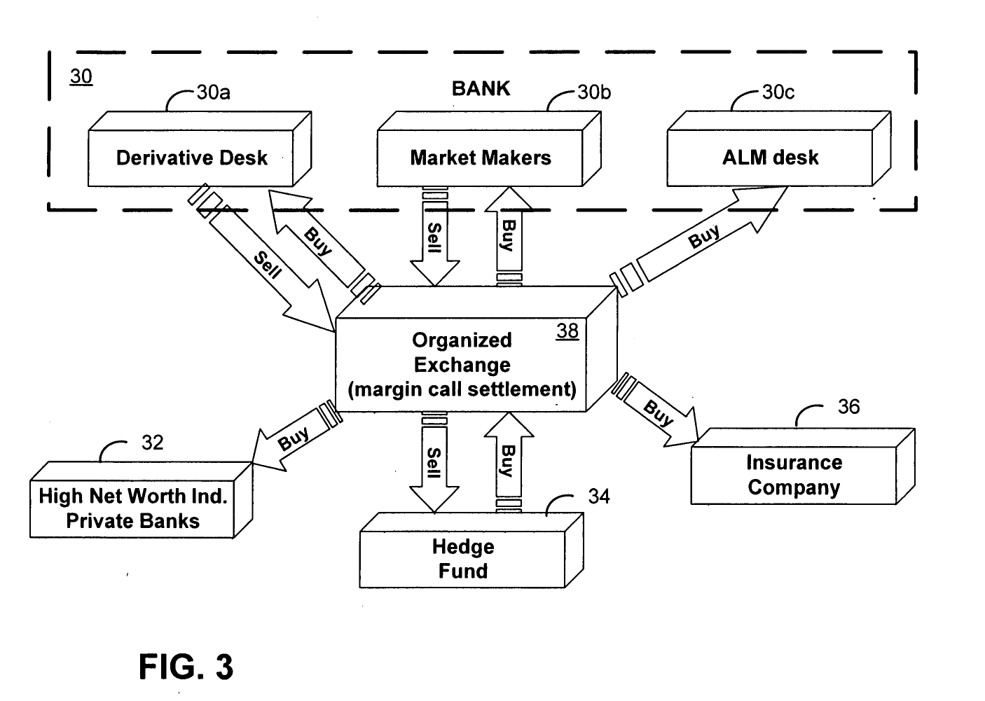

FIG. 3 illustrates an exemplary network of market participants and exchange flows. In this example, bank 30, private banks and high net worth individuals 32, hedge fund 34, and insurance company 36 all buy and sell financial instruments via organized exchange 39. Bank 30 has several functions in dealing with exchange 39. For example, bank 30 has a derivatives desk 30a that primarily serves the function of assessing the banks financial risk and consequently buys and sells derivative instruments to hedge the banks financial risk. Bank 30 also an ALM (Asset Liability Management) Desk 30c that works out the maturity pattern of assets and liabilities, also analyzes their interest rate sensitivity. Additionally, bank 30 has market makers 30b that make a market in particular security. Hence the market makers 30b buy and sell securities via exchange 38.

The participants may operate in the computing network described above with respect to FIG. 2. For example the various market participants 30, 32, 34, 36 may have one or more client computers that each uses to access exchange 39. Exchange 39 may have one or more server computers 11 to facilitate the exchange process.

As noted above, the globalization of the financial markets has shown the risks posed by the effect of correlation between major macro-economic factors or between major markets and has increased the need to reduce this risk. Correlation is mathematically defined as a statistical measure that gives the strength of dependency of the relative movements between two variables. A lot of financial actors exposure to correlation risk, like insurance companies, mutual funds, hedge funds, banks, and so on. There is a very strong link between a correlation increase and short-term systemic (or global, or macro economic) risk because when systemic risk increases all assets have a tendency to become strongly correlated. In other words, correlation increases with systemic risk. Insurances and banks have a need to hedge their short-term systemic risk exposure.

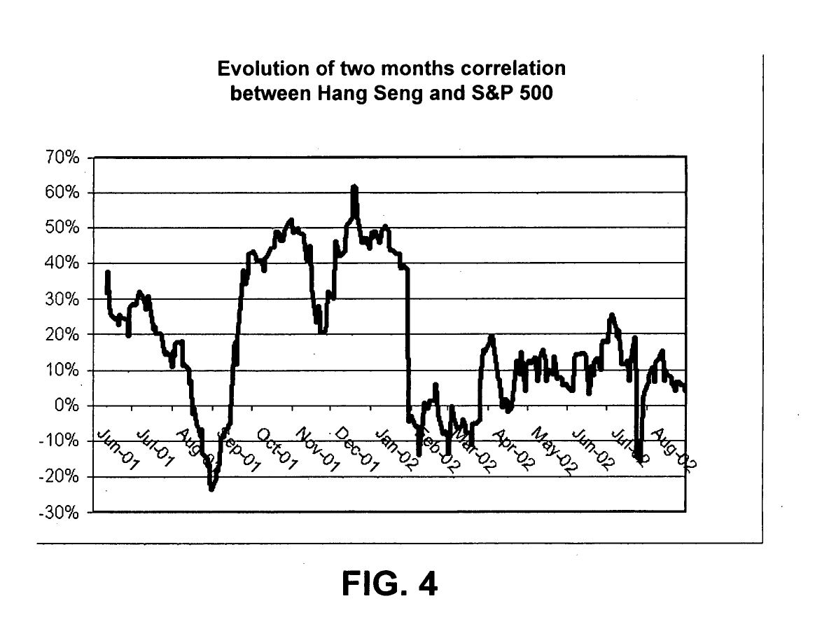

FIG. 4 shows as an example the evolution of two month rolling historical correlation between two main indices, the Hong Kong Hang-Seng and the S&P 500. It is interesting to notice that short-term correlation between these two assets is all but constant along time, which highlights the need for protection from correlation risk.

The correlation between two variables x₁(i) and x₂(i) is mathematically defined through the correlation coefficient by the following formula:

$$[ \frac{\frac{1}{n} {\sum }_{i = 1}^{n} ( {x}_{1} ( i ) - {X}_{1} ) ( {x}_{2} ( i ) - {X}_{2} )}{\sqrt{\frac{1}{n} {\sum }_{i = 1}^{n} {[ ( {x}_{1} ( i ) - {X}_{1} ) ]}^{2}} \sqrt{\frac{1}{n} {\sum }_{i = 1}^{n} {[ ( {x}_{2} ( i ) - {X}_{2} ) ]}^{2}}} ]$$

where Xₚ is the mean of variable xₚ(i) defined as

$${X}_{p} = \frac{1}{n} {\sum }_{i = 1}^{n} {x}_{p} ( i )$$

The value of the correlation coefficient is between −1 and +1. For these two values, the two underlying variables are highly correlated. A correlation of zero means that the two variables are not correlated.

The above formula is simplified when considering zero mean variables. From this definition, the correlation level observed during a n month duration between two underlying assets may be defined by the following formula:

$$[ \frac{{\sum }_{i = 1}^{n} {p}_{1} ( i ) {p}_{2} ( i )}{\sqrt{{\sum }_{i = 1}^{n} {[ {p}_{1} ( i ) ]}^{2}} \cdot \sqrt{{\sum }_{i = 1}^{n} {[ {p}_{2} ( i ) ]}^{2}}} ]$$

where p₁(i) is the monthly performance for month / of the first underlying asset and p₂(i) is the monthly performance for month i of the second underlying asset.

The first step of the method according to one embodiment of the present invention is to identify the financial variables—namely the underlying assets—for which the correlation risk is to be hedged. Preferably, the method discounts the drift effect (i.e., the value of the average of performances), which doesn't impact the correlation between underlying assets. The product should have a payoff that can be easily used for computer simulations in order to produce a theoretical value for hedging, closing and/or settlement purposes. The range of possible underlying assets for a correlation product is very large, making it difficult to identify which ones could attract liquidity. According to a preferred embodiment of the invention, global macro economic factors will be selected: equity indices, short term and long term interest rates and foreign exchanges rates.

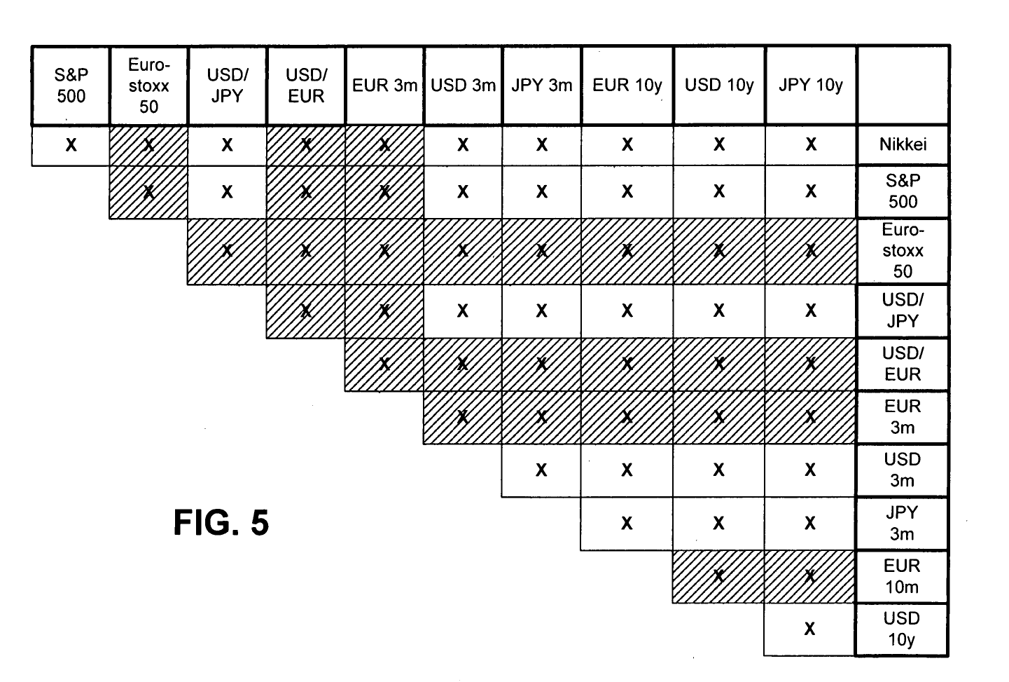

FIG. 5 is an illustration of how the underlying assets can be chosen, taking for example Europe, the USA and Japan as a starting point. A set of eleven assets have been chosen and for each pair selectable from this set, at least one contract will be launched for a given duration. Several contracts may be launched for each pair of assets.

For example if we suppose to launch six months, one year and two years contracts, that would make a total of 165(55×3=165) contracts as a start.

It is possible to restrict contracts with at least one underlying asset “EUR” denominated for Euro-based customers (shadowed in the FIG. 2), which would restrict the total number of contracts to 102(34×3=102) contracts.

For each pair of selected variable, a product is defined that must fulfill several requirements to be an efficient hedging product and to attract volume and interest from market players.

The product should have an increasing sensitivity, preferably a linear sensitivity, to correlation between the two underlying variables. It should have a low sensitivity to volatility. It should be a notional product to be quoted on listed markets and should not have a negative price. Its payoff depends on the performance of the two underlying assets. Its characteristics should remain constant along time (i.e. it can be used to hedge correlation during its entire life).

According to a preferred embodiment of the invention, the final payoff for a n month product is defined by the above formula:

$$p = 100 * [ 1 + \frac{{\sum }_{i = 1}^{n} {p}_{1} ( i ) {p}_{2} ( i )}{\sqrt{{\sum }_{i = 1}^{n} {[ {p}_{1} ( i ) ]}^{2}} \cdot \sqrt{{\sum }_{i = 1}^{n} {[ {p}_{2} ( i ) ]}^{2}}} ]$$

where p₁(i) is the monthly performance for month i of the first underlying asset and p₂(i) is the monthly performance for month i of the second underlying asset.

The concept can be generalized to more than two underlying assets and provide a combined correlation for all underlying assets without departing from the scope or the spirit of the invention. In a preferred embodiment of the invention the definition of the product is restricted to two underlying assets to get an improved tuning and risk hedging through an increased sensitivity of the product to the correlation between two separate assets.

The settlement of the contract depends on the type of the product. The settlement is done according to the cash settlement rules if the product is quoted on a futures market and to standard ISDA (International Swap and Derivatives Association) rules if the product is negotiated over the counter, knowing that the final payoff is always calculated at expiry. In the case of cash-settlement, the settlement is done by accumulation of daily margin calls and for an OTC negotiated product the final payoff is paid by the seller (or issuer) of the product. In any of both previously mentioned cases, the performances of each underlying asset have to be stored at each observation date (end of day closing recommended) so as to be used in the calculation of the final payoff.

The payoff of the product can also take the following form:

$$\frac{{Perf}_{1} ( Mat ) \times {Perf}_{2} ( Mat )}{{{Perf}_{1} ( Mat )}^{2} + {{Perf}_{2} ( Mat )}^{2}} ,$$

Perf(Mat) meaning the performance over the full life of the product (only one intermediate period). This product also has the same characteristics (Sensitive to correlation, Cross Gamma hedging, Hyperbolic Paraboloid shape) as the previous one but raises some hedging issues when both performances at maturity are near to zero.

From this definition the hedging product has the following characteristics:

it is a notional product,

it has a fixed maturity that corresponds to the term of the implied correlation,

its payoff depends on two underlying assets (it is not a basket product), and its theoretical value should have a linear sensitivity to the level of the correlation coefficient of both underlying products (e.g., worth 200 for a correlation level of 100% for similar underlying products, e.g. of a merger between two shares, 100 for a correlation of 0%, about 150 for a correlation of 50% or about 50 for a correlation of −50% at first issue date).

In addition, it has the following advantages:

its payoff is simple and clear to understand,

it is easy and cheap to administrate,

it enables market makers to trade it thanks to simple cross-gamma hedging,

it can be equally attractive for sellers and buyers as it uses cash settlement in order to respect equity between sellers and buyers,

the loss or gain is always limited for a buyer or a seller,

it has no sensitivity to foreign exchange rates, unless one of the underlying asset is an exchange rate or a product sensitive to an exchange rate.

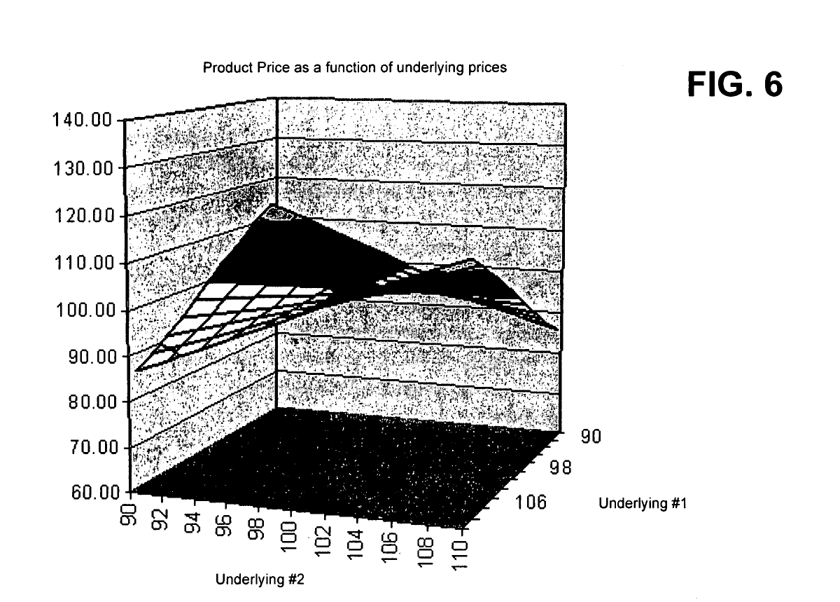

FIG. 6 shows the price of product as a function of both underlying prices: The main characteristic of this pay-off is to have the shape of a hyperbolic paraboloid, which means a linearity to both products to the value changes of each underlying individually. The slope of this linearity (delta) to an underlying product linearly depends on the value of the other underlying (constant cross gamma). This is the main reason why a cross delta hedging is possible on the product. In other words, the amount required to hedge the product against the first underlying asset only depends on the movements of the second underlying asset.

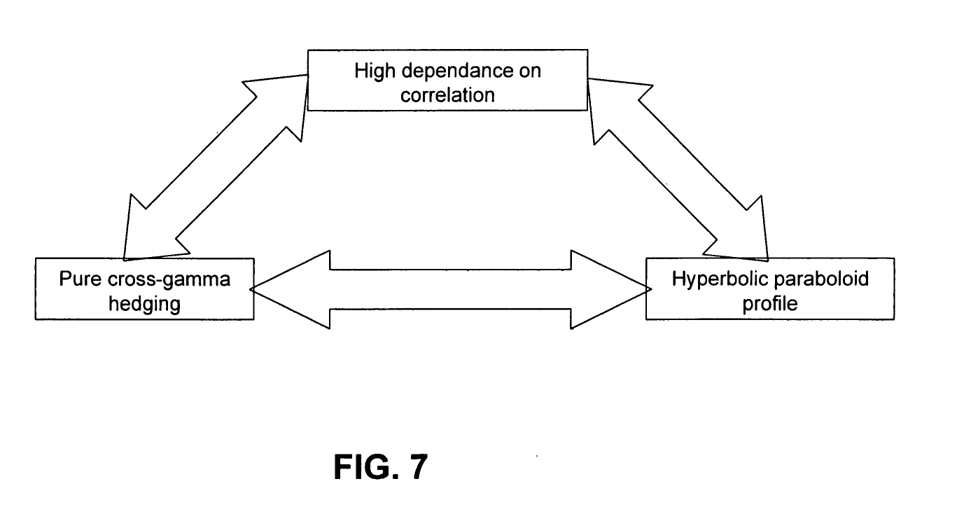

FIG. 7 illustrates that the product exhibits a high dependence on correlation and is in fact preferably linearly sensitive to correlation. Additionally, it has a constant cross-gamma, i.e., the sensitivity (slope) to one underlying asset linearly depends on the value of the other asset and the payoff has a paraboloid hyperbolic shape.

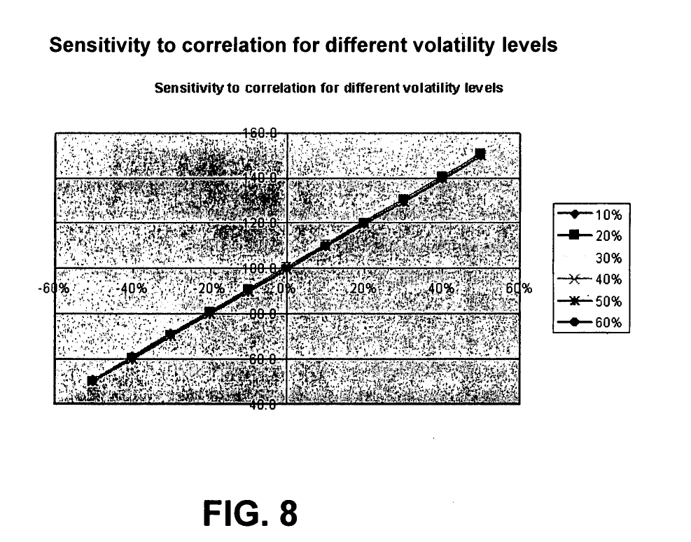

FIG. 8 show the sensitivity of the product to the correlation level, for different volatility levels (both underlying products have the same volatility):

The product has a linearity to the level of correlation, without being too dependant on the volatility level.

It is not necessary to consider the performance of the underlying assets on a monthly basis. Any other schedule may be chosen (daily, weekly schedule for example or a more complex schedule) as long as the schedule is precisely defined before the contract is launched. To select the appropriate schedule, the cost of the product management has to be considered. The highest the chosen frequency of the scheduled dates is, the heaviest the management of the product is.

In a preferred embodiment of the invention, rules are defined to calculate a missing quotation in the case one of the two underlying asset has not been quoted at a given date.

In order to implement the described method, it is necessary to use tools that can handle a very broad range of asset classes. They have to be flexible and very powerful in order to be able to handle and define any underlying asset. They are also able to define the notional products according to the above described method, to store the intermediate performances of each underlying asset and to calculate the final payoff of the products from said intermediate performances.

In a preferred embodiment these tools are also able to simulate the volatility of any underlying asset as well as to calculate the product payoff according to the quotation rules or to estimate the product payoff according to market data, product data or any pricing data. Such implementation means enable therefore the pricing and/or risk management of the product.

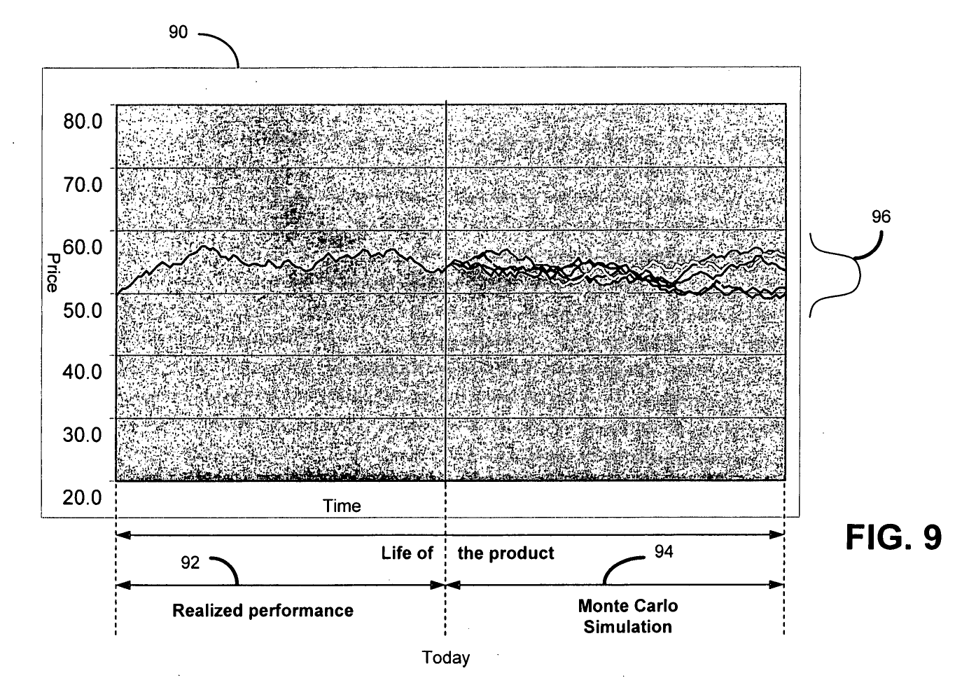

FIG. 9 illustrates a model 90 for determining the future price of an underlying asset by way of Monte Carlo simulation. The price of the underlying asset is shown along the x-axis, and time is shown along the y-axis. The realized performance 92 of the asset is used to estimate volatility. That information is then used to simulate the price of the asset up to the date of maturity 94. The simulation is performed a number of times to provide a distribution 96 of simulated asset price behavior. The various simulations are then averaged together to provide an average simulated price. This provides a time series for one underlying asset.

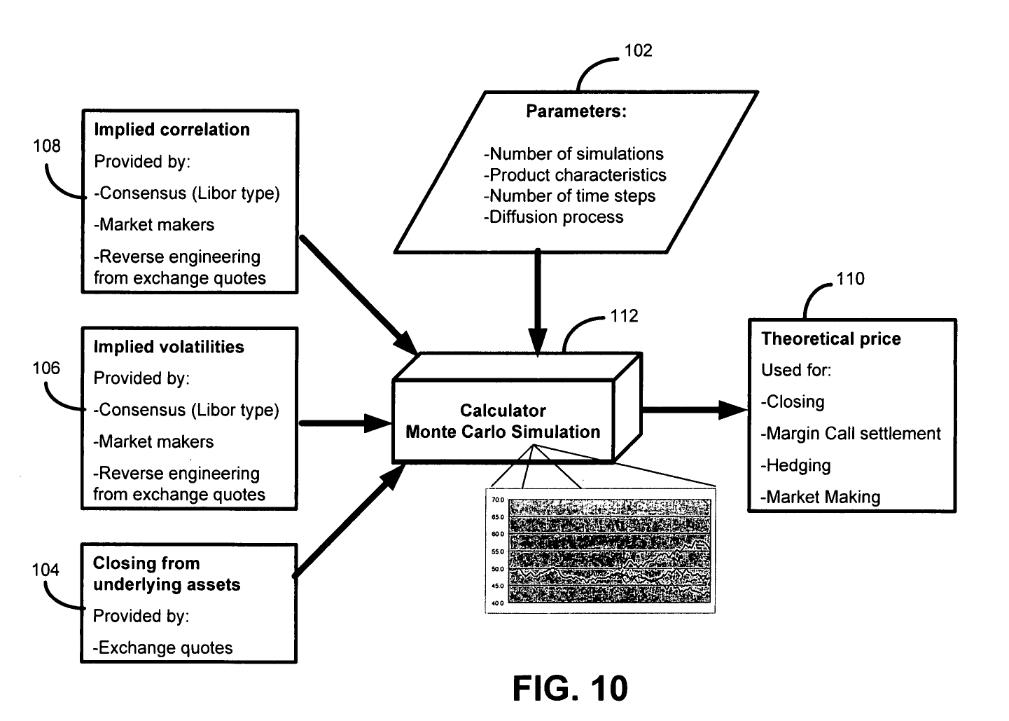

FIG. 10 provides a flow chart that illustrates the generation of the correlation derivative in accordance with an aspect of the invention. To that end, a set of parameters 102 is input into the system. The parameters 102 include such information as the product characteristics (e.g., the underlying assets to correlate), the number of simulations to perform (e.g., the number of simulations 96 as shown in FIG. 9), the number of time steps (e.g., hourly, daily, monthly pricing), the diffusion process used to determine the asset price changes, and so on. After the initial parameters 102 are input and the underlying assets are determined, the closing prices of the assets are determined (e.g., from an exchange). Additionally, the implied volatilities 106 of the underlying assets are determined. The implied volatilities can be provided according to a number of pre-existing methods, such as consensus mechanism, from market makers, or by financial models such as Black-Sholes. An implied correlation 108 can be determined by consensus, market makers, or by a financial models. This information is then put into Monte Carlo simulation 112 and used to calculate a theoretical price 110 for the correlation derivative. If traded on an organized market, the daily settlement of the products can be done in any number of ways such as using the last traded price, using a mid price between the last bid and offer, by using a theoretical pricing (as described previously), by using a consensus between market participants (Libor type).

The use of the method and system according to the invention is clearly of high interest for a lot of actors of the financial markets. Globally, each market player (individual, corporate, bank, asset manager, institutional investor) can have a specific interest to buy or sell correlation. It can be for hedging purpose, speculation, arbitrage, or to diversify an investment portfolio. Different market players will have different objectives and interests, depending on their risk exposure, specific interest and investor profile.

A bank is globally negatively exposed to systemic risk and is likely to be a buyer in correlation of macro economic factors. On the other hand, this bank might have issued some products containing positive exposure to correlation and can have an interest to sell it for hedging purpose. Also some bank can accept to play the role of market makers on these products and supply liquidity.

An insurance company has a massive exposure to systemic risk, she might be a buyer of correlation.

A hedge fund can have both interest of selling or buying correlation between interest rates, equities or foreign exchanges depending on the manager view. He can be a seller in a period where correlation is “overbought” or buyer when it is “oversold” and plays a role of liquidity supplier, as an arbitrager would do.

A corporate treasurer can be both a seller and buyer of the forex/IR correlation according to its macro economic forecasts.

Having described and illustrated the principles of the present invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of the present invention may be applied, it should be recognized that the detailed embodiments are illustrative only and should not be taken as limiting the scope of my invention. Rather, the invention includes all such embodiments as may come within the scope and spirit of the following claims and equivalents thereto.

What is claimed:

1. A method for correlation risk hedging comprising:
selecting at least two underlying assets; and
providing a product having a payoff value wherein the payoff value is a function of the similarity of the behavior of the intermediate performances of the at least two underlying assets, each intermediate performance being related to the time period between two successive intermediate dates.

2. The method according to claim 1 wherein the payoff value is value negotiated for a product traded on an over the counter (OTC) market.

3. The method according to claim 2 wherein said at least one product is quoted on a futures market.

4. The method according to claim 1 wherein said product comprises an expiry date and wherein the payoff at the expiry date is determined by:
$$p = 100 * [ 1 + \frac{{\sum }_{i = 1}^{n} {p}_{1} ( i ) {p}_{2} ( i )}{\sqrt{{\sum }_{i = 1}^{n} {[ {p}_{1} ( i ) ]}^{2}} \cdot \sqrt{{\sum }_{i = 1}^{n} {[ {p}_{2} ( i ) ]}^{2}}} ]$$
wherein n+1 is the number of said intermediate dates, the intermediate date 0 being said initiation date, p₁(i) is the performance between intermediate dates i-1 and i of said first underlying asset and p₂(i) is the performance between intermediate dates i-1 and i of said second underlying asset.

5. The method according to claim 1 wherein each underlying asset is a foreign-exchange rate, an index level, an equity indices or an interest rate.

6. The method according to claim 4 wherein said intermediate performances are monthly, weekly or daily performances.

7. The method according to claim 1 wherein the product value is determined by a monte carlo simulation.

8. The method according to claim 1 wherein the product value is determined by a consensus mechanism.

9. A system for correlation risk hedging comprising:
a computer processing unit;
memory device couple to said computer processing unit; and
computer-readable instructions stored in said memory, said computer-readable instructions capable of carrying out the functions of:
selecting at least two underlying assets; and
determining a payoff value for a product wherein the payoff value is a function of the similarity of the behavior of the intermediate performances of the at least two underlying assets, each intermediate performance being related to the time period between two successive intermediate dates.

10. The system according to claim 9 wherein the payoff value is value negotiated for a product traded on an over the counter (OTC) market.

11. The system according to claim 10 wherein said at least one product is quoted on a futures market.

12. The system according to claim 9 comprising computer-readable instructions stored in the memory wherein said product comprises an expiry date and wherein the payoff at the expiry date is determined by:
$$p = 100 * [ 1 + \frac{{\sum }_{i = 1}^{n} {p}_{1} ( i ) {p}_{2} ( i )}{\sqrt{{\sum }_{i = 1}^{n} {[ {p}_{1} ( i ) ]}^{2}} \cdot \sqrt{{\sum }_{i = 1}^{n} {[ {p}_{2} ( i ) ]}^{2}}} ]$$
wherein n+1 is the number of said intermediate dates, the intermediate date 0 being said initiation date, p₁(i) is the performance between intermediate dates i-1 and i of said first underlying asset and p₂(i) is the performance between intermediate dates i-1 and i of said second underlying asset.

13. The system according to claim 9 wherein each underlying asset is a foreign-exchange rate, an index level, an equity indices or an interest rate.

14. The system according to claim 12 wherein said intermediate performances are monthly, weekly or daily performances.

15. The system according to claim 9 wherein the product value is determined by a monte carlo simulation.

16. The system according to claim 9 wherein the product value is determined by a consensus mechanism.

17. A product for correlation risk hedging comprising:
a price wherein the price is a function of an implied correlation of at least two assets; and
an expiry date wherein the expiry date has a term that is the same term as a term of the implied correlation.

18. The product according to claim 17 wherein the price is a function of an implied volatility of the at least two assets.

19. The product according to claim 17 wherein the product is negotiated on an exchange.

20. The product according to claim 17 wherein the price is determined according to a monte carlo simulation.
